(19) United States
(12) Patent Application Publication
(10) Pub. No.: US 2015/0213478 A1
(43) Pub. Date: Jul. 30, 2015

(54) METHOD AND SYSTEM FOR ALLOWING TIME-BASED, INCREMENTAL POINT ACCELERATION

(71) Applicant: MasterCard International Incorporated, Purchase, NY (US)

(72) Inventor: Christopher A. GUINEY, Fenton, MO (US)

(73) Assignee: MasterCard International Incorporated, Purchase, NY (US)

(21) Appl. No.: 14/166,087

(22) Filed: Jan. 28, 2014

(51) Int. Cl. G06Q 30/02

(52) U.S. Cl. CPC G06Q 30/0231; G06Q 30/0235

(57) ABSTRACT

A method for awarding time-based incremental rewards for a payment transaction includes: storing a reward rule, wherein the reward rule includes at least a base amount, an increase amount, and a predetermined period of time; storing a first transaction data entry, wherein the first transaction data entry includes data related to a completed transaction including at least a transaction time and/or date; receiving, by a receiving device, transaction data for a payment transaction, wherein the transaction data includes at least a time and/or date; and identifying, by a processing device, a reward amount for the payment transaction if the time and/or date included in the received transaction data is within the predetermined period of time of the transaction time and/or date included in the first transaction data entry, wherein the reward amount is based on at least the base amount and increase amount included in the reward rule.

### FIELD

The present disclosure relates to the awarding of time-based incremental rewards for a payment transaction, specifically the incremental acceleration of points or other rewards for a payment transaction based on time elapsed since previous transactions.

### BACKGROUND

Payment cards, such as credit cards, debit cards, etc. can be a beneficial tool for consumers to use. Because of the utility of payment cards, many consumers may have multiple payment cards, and in some instances may possess payment cards from multiple issuers. As a result, issuers may often try and provide incentives for consumers to use payment cards that they have issued. One such incentive is the use of reward points, cash back, or other type of currency that may be redeemed by the consumer, that may be awarded for eligible purchases made using associated payment cards.

However, as more and more payment cards begin to offer rewards for their use, such reward programs may no longer be attractive enough to consumers to influence payment card use due to the similarities between programs offered by each payment card. As a result, issuers may be interested in additional methods for incentivizing use of a payment card. Thus, the present inventor believes there is a need for additional systems and methods for providing incentives to consumers for use of a payment card.

### SUMMARY

The present disclosure provides a description of systems and methods for awarding time-based incremental rewards for a payment transaction.

A method for awarding time-based incremental rewards for a payment transaction includes: storing, in a reward database, a reward rule, wherein the reward rule includes at least a base amount, an increase amount, and a predetermined period of time; storing, in a transaction database, a first transaction data entry, wherein the first transaction data entry includes data related to a completed transaction including at least a transaction time and/or date; receiving, by a receiving device, transaction data for a payment transaction, wherein the transaction data includes at least a time and/or date; and identifying, by a processing device, a reward amount for the payment transaction if the time and/or date included in the received transaction data is within the predetermined period of time of the transaction time and/or date included in the first transaction data entry, wherein the reward amount is based on at least the base amount and increase amount included in the reward rule.

A system for awarding time-based incremental rewards for a payment transaction includes a reward database, a transaction database, a receiving device, and a processing device. The reward database is configured to store a reward rule, wherein the reward rule includes at least a base amount, an increase amount, and a predetermined period of time. The transaction database is configured to store a first transaction data entry, wherein the first transaction data entry includes data related to a completed transaction including at least a transaction time and/or date. The receiving device is configured to receive transaction data for a payment transaction, wherein the transaction data includes at least a time and/or date. The processing device is configured to identify a reward amount for the payment transaction if the time and/or date included in the received transaction data is within the predetermined period of time of the transaction time and/or date included in the first transaction data entry. The reward amount is based on at least the base amount and increase amount included in the reward rule.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for awarding time-based incremental rewards for a payment transaction in accordance with exemplary embodiments.

FIG. 2 is a block diagram illustrating the processing server of FIG. 1 for the identification of an incremental time-based reward amount for a payment transaction in accordance with exemplary embodiments.

FIG. 3 is a flow diagram illustrating a process for the awarding of time-based incremental rewards for a payment transaction using the system of FIG. 1 in accordance with exemplary embodiments.

FIG. 4 is a flow diagram illustrating a process for identification a reward amount for a payment transaction using the processing server of FIG. 2 in accordance with exemplary embodiments.

FIG. 5 is a flow chart illustrating an exemplary method for awarding time-based incremental rewards for a payment transaction in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Awarding Time-Based Incremental Rewards

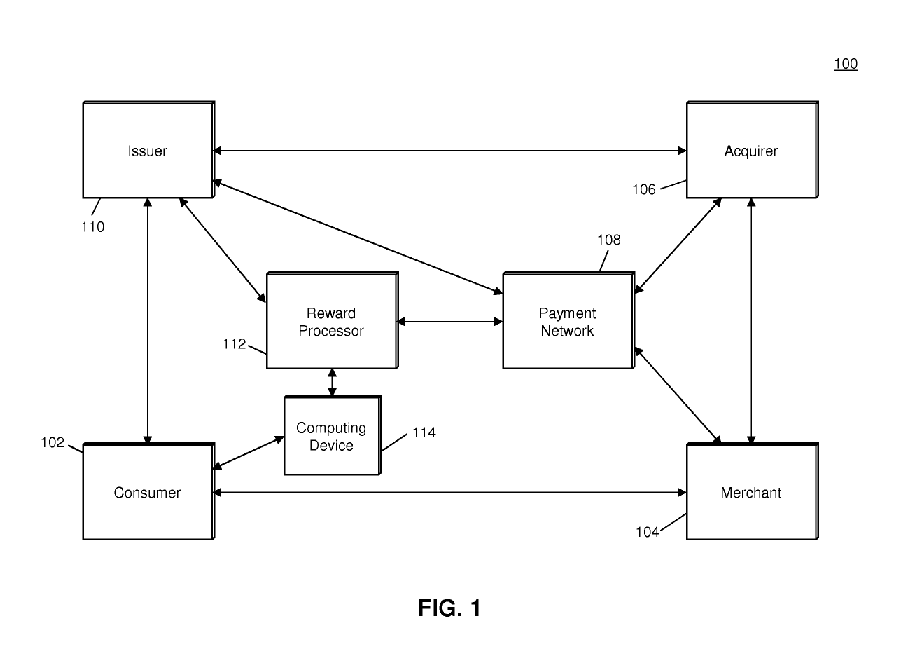

FIG. 1 illustrates a system 100 for the awarding of time-based incremental rewards for a payment transaction.

The system 100 may include a consumer 102. The consumer 102 may have a payment account with an issuer 110. The issuer 110 may issue a payment card to the consumer 102 that is associated with the payment account, which the consumer 102 may use to conduct payment transactions to be funded by the associated payment account. The payment card may be further associated with a program for awarding incremental, time-based rewards, which may be implemented using the systems and methods discussed herein.

The consumer 102 may engage in a payment transaction with a merchant 104. As part of the payment transaction, the consumer 102 may present the payment card and/or payment details corresponding to the associated payment account using methods and systems that will be apparent to persons having skill in the relevant art. For example, the consumer 102 may present a physical payment card for payment, pay a wallet application on a mobile device (e.g., using a machine-readable code, near field communication, etc.), or other suitable method for conveying payment account details.

The merchant 104 may receive the payment information, and may transmit the payment information and transaction data to an acquirer 106. The acquirer 106 may generate an authorization request for the payment transaction, which may be submitted to a payment network 108. The payment network 108 may receive the authorization request and may process the request using methods and systems that will be apparent to persons having skill in the relevant art. Processing of the authorization request may include transmitting transaction data to the issuer 110, who may then identify if the associated payment account includes a suitable amount of credit and/or funds for the payment transaction. In some embodiments, the acquirer 106 may communicate directly with the issuer 110 for approval or denial of the payment transaction.

Once the transaction has been processed, an authorization response may be routed to the merchant 104 (e.g., via the acquirer 106). The merchant 104 may then finalize the transaction with the consumer 102, such as by furnishing the requested goods and/or services, providing a receipt to the consumer 102, etc. It will be apparent to persons having skill in the relevant art that the payment transaction between the consumer 102 and merchant 104 may be an in-person transaction (e.g., at a physical location of the merchant 104) or may be a remote transaction, such as via the Internet, telephone, mail, etc.

The payment network 108 and/or the issuer 110 may provide transaction data for the payment transaction to a reward processor 112. The reward processor 112, discussed in more detail below, may be configured to identify a reward amount to be awarded to the consumer 102 based on the payment transaction. The award may be for an incremental, time-based reward that starts at a base amount and increases by a specific increase amount over time with each new transaction. For example, a first transaction may receive 1 point per dollar spent, a second transaction may receive 1.2 points per dollar spent if performed within 24 hours of the first transaction, a third transaction may receive 1.4 points per dollar spent if performed within 24 hours of the second transaction, etc. In another example, the reward may increase for a set period of time. For instance, an increase may be applied to transactions for a first 24 hour period following a transaction, and then another increase for a second 24 hour period if a transaction was conducted during the first period.

Once the reward amount is identified by the reward processor 112, the reward processor 112 may notify the issuer 110 of the reward amount. In some embodiments, the reward processor 112 may also notify the consumer 102, such as via a computing device 114. The computing device may be any type of computing device suitable for receiving data and displaying data to the consumer 102, such as a desktop computer, laptop computer, cellular phone, smart phone, etc.

In some embodiments, the reward processor 112 may be part of the payment network 108 and/or the issuer 110. In instances where the reward processor 112 is part of the payment network 108, the reward amount for the payment transaction may be identified using transaction data included in the authorization request received from the acquirer 106 and/or the merchant 104. In instances where the reward processor 112 is part of the issuer 110, the reward processor may store a consumer profile associated with the consumer 102, and may update a reward amount associated with the consumer 102 based on the reward earned in the payment transaction.

The incremental, time-based rewards awarded to the consumer 102 for the payment transaction may be in the form of points, cash back, coupons, deals, or any other suitable form of award as will be apparent to persons having skill in the relevant art. For example, as discussed above, points may be awarded to the consumer 102 and may increase over time. In another example, coupons may be awarded to the consumer 102 with one or more properties of the coupon increasing over time, such as a larger discount, larger maximum transaction amount limit, lower minimum transaction amount, higher use quantity, etc.

In some instances, the consumer 102 may first sign up to be eligible for rewards. For example, the consumer 102 may register with the issuer 110 and/or reward processor 112 in order for payment transactions to be considered eligible for the awarding of rewards. In some embodiments, the consumer 102 may be required to register each time a new reward rule established. For instance, the issuer 110 may start a new promotion where incremental, time-based rewards are available for transactions, but transactions may be ineligible until the consumer 102 actively signs up for the promotion (e.g., via the computing device 114).

The use of time-based, incremental rewards may incentivize consumers to use a payment card when they may have otherwise used a different payment method or instrument. The incrementing of a reward over time may not only influence a consumer to use an associated payment card, but may also influence continual use of the card. Additional considerations may be used to affect the rewards to further influence consumers regarding merchants, locations, or times. For example, rewards may be incremented over time and based on a geographic location of the transactions, such as incrementing for transactions conducted at nearby merchants to a first merchant. In some instances, the issuer 110 may set limits on the rewards to incentivize consumers without negatively affecting the issuer 110 or merchants 104, such as due to an overabundance of awarded rewards. For example, an incremental, time-based reward may be effective only during a certain period of time, may have a maximum increase amount, or may have associated transaction amount limits. Additional criteria that may be associated with incremental, time-based rewards as discussed herein will be apparent to persons having skill in the relevant art.

### Reward Processor

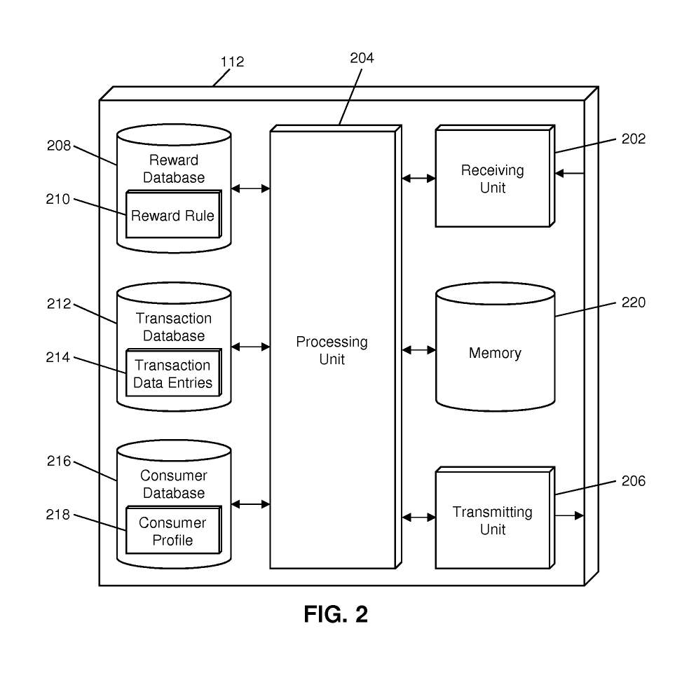

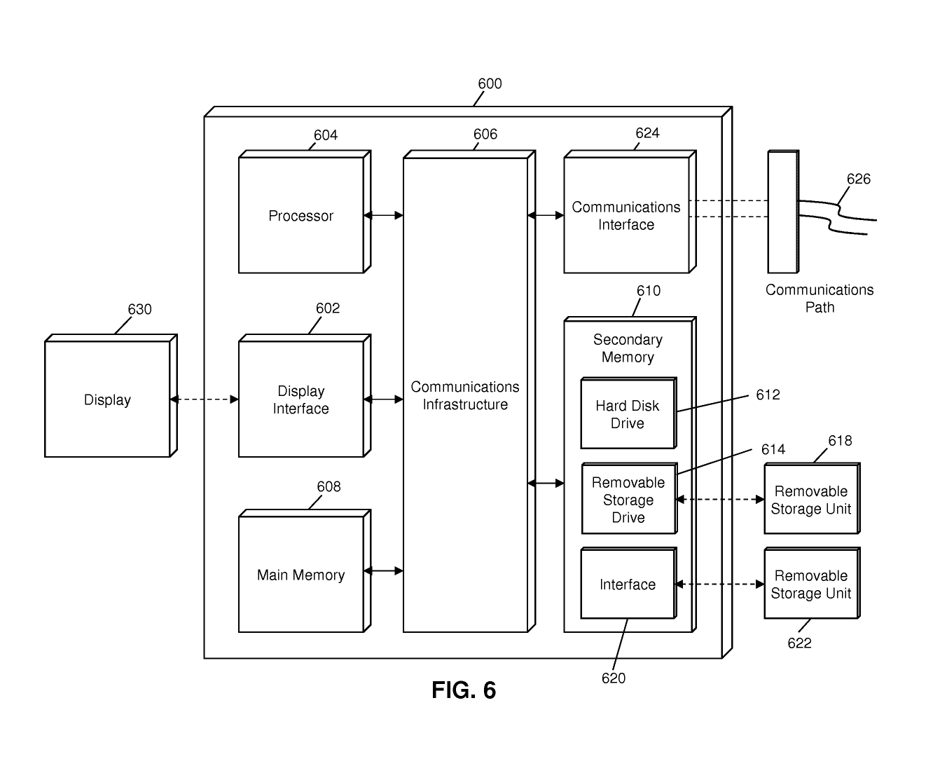

FIG. 2 illustrates an embodiment of the reward processor 112 of the system 100. It will be apparent to persons having skill in the relevant art that the embodiment of the reward processor 112 illustrated in FIG. 2 is provided as illustration only and may not be exhaustive to all possible configurations of the reward processor 112 suitable for performing the functions as discussed herein. For example, the computer system 600 illustrated in FIG. 6 and discussed in more detail below may be a suitable configuration of the reward processor 112.

The reward processor 112 may include a receiving unit 202. The receiving unit 202 may be configured to receive data over one or more networks via one or more network protocols. The receiving unit 202 may receive reward information from the issuer 110 regarding a reward program to be conducted to award consumers 102 with incremental, time-based rewards. The reward information may include at least a base amount, an increase amount, and a predetermined period of time.

The reward processor 112 may include a processing unit 204. The processing unit 204 may be configured to identify the data included in the reward information and store the data in a reward database 208 as a reward rule 210. The reward rule 210 may include at least the base amount, increase amount, and predetermined period of time, and may further include any other suitable information regarding the associated reward. For example, the reward rule 210 may further include a maximum amount (e.g., where the reward may not exceed the maximum amount), a time limit (e.g., where rewards may not be awarded after the time limit), a transaction limit (e.g., a maximum number of transactions for which rewards may be awarded during each predetermined period of time), etc.

The receiving unit 202 may receive transaction data for a payment transaction, such as from the payment network 108, issuer 110, merchant 104, or acquirer 106. The transaction data may include at least a time and/or date of the transaction, such as the time and/or date when the transaction was authorized, processed, cleared, initiated, etc. The processing unit 204 may be configured to store the received transaction data in a transaction database 212 as a transaction data entry 214. The transaction data entry 214 may include data related to the payment transaction including at least the time and/or date. Additional transaction data that may be received by the receiving unit 202 and stored in the transaction data entry 214 may include a transaction amount, consumer identifier, merchant data, product data, or other suitable data as will be apparent to persons having skill in the relevant art.

The processing unit 204 may be further configured to identify if a payment transaction for which transaction data is received is eligible for rewards based on the reward rule 210. Methods and processes for identifying the eligibility of a payment transaction for rewards will be apparent to persons having skill in the relevant art. For example, the processing unit 204 may identify if a transaction amount for the payment transaction exceeds a minimum transaction amount included in the reward rule 210. In another example, the payment transaction may be required to be conducted at a geographic location (e.g., as included in the received transaction data) within a predetermined distance of a prior transaction, such as multiple transactions conducted within a shopping mall. If the payment transaction is eligible, the processing unit 204 may be configured to identify a reward amount for the transaction.

As discussed in more detail below, the reward amount may be the base amount included in the reward rule 210, or may be further increased by the increase amount based on prior eligible transactions involving the consumer 102. Identification of prior eligible transactions involving the consumer 102 may include identifying transaction data entries 214 stored in the transaction database 212 for payment transactions involving the consumer 102 that were conducted within the predetermined period of time, as set in the reward rule 210, of the newly conducted payment transaction. For example, if the predetermined period of time is 24 hours, then the processing unit 204 may identify if any eligible transactions were conducted within the previous 24 hours to the present payment transaction.

If prior transactions were identified, then the reward amount may be based on the base amount and the increase amount. In some instances, the reward amount may be further based on an amount awarded in the prior payment transaction. For example, the increase amount may be applied to the amount awarded in the prior payment transaction such as the reward continues to increment with each subsequent payment transaction. In another example, the increase amount may be applied to the base amount a number of times based on criteria included in the reward rule 210, such as increasing for each consecutive predetermined period of time for which a payment transaction was conducted prior to the present payment transaction.

The reward processor 112 may further include a transmitting unit 206. The transmitting unit 206 may be configured to transmit data over one or more networks via one or more network protocols. The transmitting unit 206 may transmit the identified reward amount to the issuer 110 for awarding to the consumer 102. In some embodiments, the transmitting unit 206 may be configured to transmit a notification to the consumer 102 (e.g., via the computing device 114) notifying the consumer 102 of the earned reward amount. The transmitting unit 206 may also be configured to transmit a notification to the consumer 102 notifying the consumer 102 of the reward being offered. For instance, the transmitting unit 206 may transmit a notification to the consumer 102 regarding a new reward program when new reward information is received by the receiving unit 202. The notification may include details regarding the reward, the incremental increase in points, the time period(s) involved, etc.

In some embodiments, the reward processor 112 may further include a consumer database 216. The consumer database 216 may be configured to store a consumer profile 218 associated with the consumer 102. The consumer profile 218 may store data related to the consumer 102 including at least a consumer identifier and a total reward amount. The consumer identifier may be a unique value associated with the consumer 102 and/or the consumer profile 218 for use in identifying the consumer 102. The consumer identifier may be a payment account number, payment card number, username, e-mail address, phone number, or other suitable value as will be apparent to persons having skill in the relevant art. The consumer identifier may be included in each transaction data entry 214 that is associated with a payment transaction involving the consumer 102, such as for use in identifying prior transactions involving the consumer 102.

The total reward amount may be a cumulative total reward amount awarded to the consumer 102 that the consumer 102 may redeem. When a reward amount for a new payment transaction is identified, the processing unit 204 may be configured to update the total reward amount included in the consumer profile 218 based on the new reward amount. In some instances, when the total reward amount is updated, the transmitting unit 206 may transmit a notification to the issuer 110 and/or the consumer 102 regarding the updated total reward amount.

The reward processor 112 may further include a memory 220. The memory 220 may be configured to store any additional data suitable for use by the processing unit 204 or other units of the reward processor 112 for performing the functions as disclosed herein. For example, the memory 220 may store algorithms for use by the processing unit 204 in identifying reward amounts, data for use in generating notifications to be transmitted to the issuer 110, consumer 102, and/or computing device 114, etc.

### Process for Awarding Incremental, Time-Based Rewards

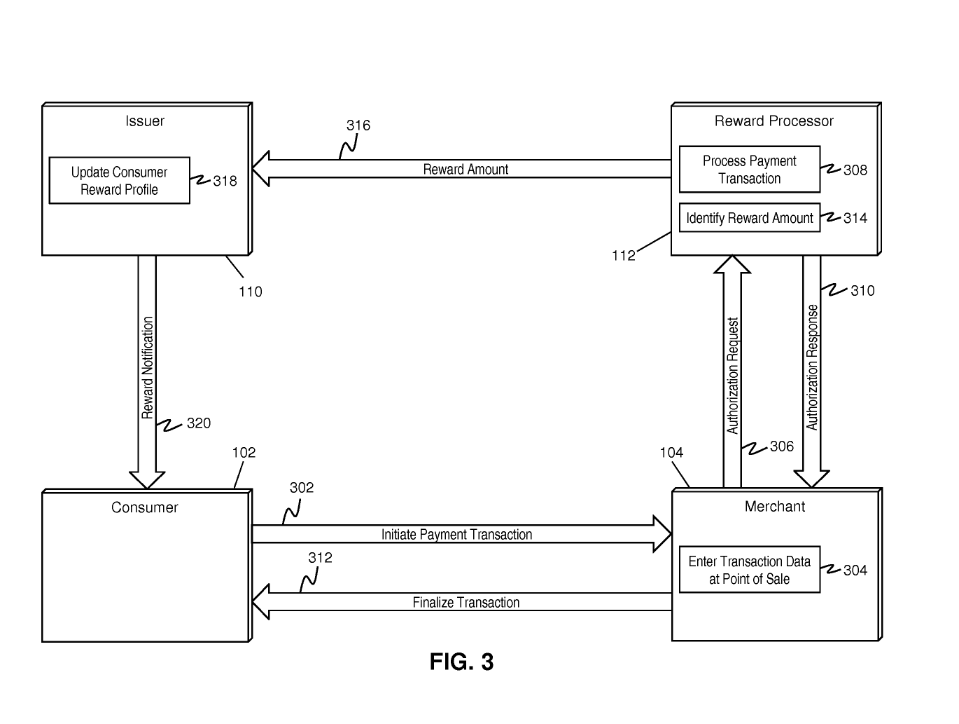

FIG. 3 illustrates a process for the awarding of incremental, time-based rewards to the consumer 102 using the system 100 of FIG. 1, discussed above. In the process illustrated in FIG. 3 and discussed below, the reward processor 112 may be included as part of the payment network 108.

In step 302, the consumer 102 may initiate a payment transaction with the merchant 104. As part of the initiation of the payment transaction, the consumer 102 may provide payment details associated with a payment account that is eligible rewards to the merchant 104. In step 304, the merchant 104 may enter transaction data for the transaction, including the payment details, in a point of sale. In step 306, an authorization request may be generated and submitted to the reward processor 112. In some instances, the authorization request may be generated and submitted by the acquirer 106 on behalf of the merchant 104. The authorization request may include transaction data for the payment transaction, including at least the payment details and a time and/or date.

In step 308, the reward processor 112 (e.g., as part of the payment network 108) may process the payment transaction using methods and systems that will be apparent to persons having skill in the relevant art. In step 310, an authorization response indicating approval of the payment transaction may be transmitted to the merchant 104 (e.g., via the acquirer 106). In step 312, the merchant 104 may finalize the payment transaction with the consumer 102, such as by furnishing the transacted-for products to the consumer 102.

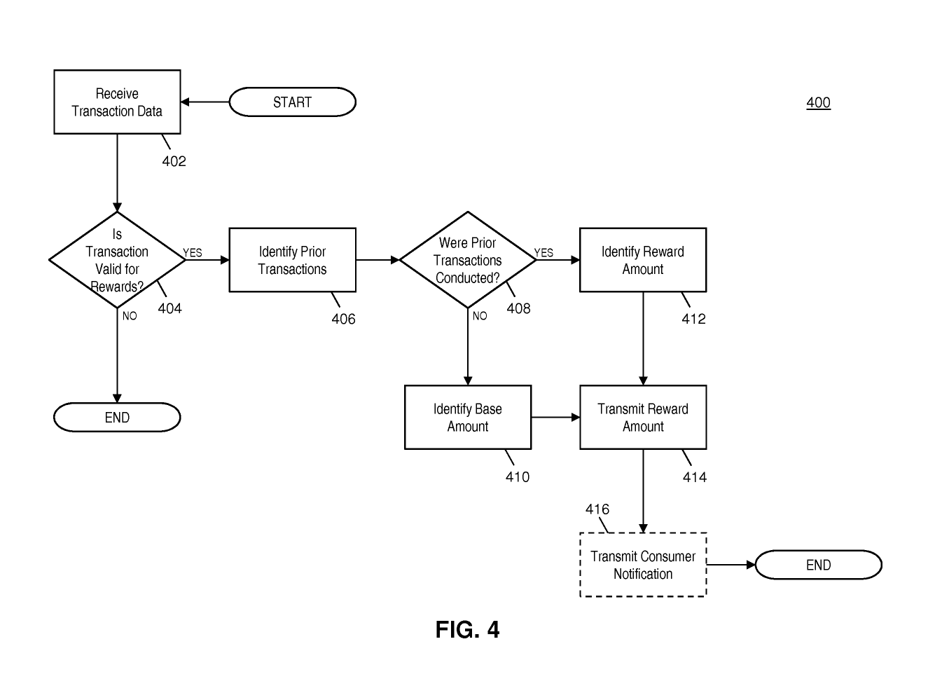

In step 314, the reward processor 112 may identify a reward amount for the payment transaction using the methods and systems discussed herein, such as the method illustrated in FIG. 4 and discussed in more detail below. In step 316, the transmitting unit 206 of the reward processor 112 may transmit the reward amount to the issuer 110. In step 318, the issuer 110 may update a consumer reward profile associated with the consumer 102 based on the identified reward amount received from the reward processor 112. The issuer 110 may also, in step 320, transmit a reward notification to the consumer 102, notifying the consumer 102 of the reward points awarded from the payment transaction.

### Process for Identifying an Incremental, Time-Based Reward Amount

FIG. 4 illustrates a process 400 for the identification of an incremental, time-based reward amount by the reward processor 112.

In step 402, the receiving unit 202 of the reward processor 112 may receive transaction data for a payment transaction involving the consumer 102. The transaction data may include at least a time and/or date for the payment transaction. In step 404, the processing unit 204 of the reward processor 112 may determine if the payment transaction is eligible for rewards. The determination of eligibility may be based on additional information including in the transaction data, and information including in the reward rule 210 stored in the reward database 208. If the payment transaction is not eligible for rewards, then the process 400 may be finished, though the transaction will likely continue.

If the payment transaction is eligible, then, in step 406, the processing unit 204 may identify if the consumer 102 conducted any prior transactions based on the criteria included in the reward rule 210. Identification of prior transactions may include identifying at least one transaction data entry 214 stored in the transaction database 212 that has an included transaction time and/or date within a predetermined period of time of the time and/or date included in the received transaction data. The predetermined period of time may be included in the reward rule 210. In some embodiments, if a prior transaction is identified, the processing unit 204 may identify other transactions that were conducted prior to the identified prior transaction. In one embodiment, identified prior transactions may be required to be eligible with one or more criteria, such as being within a predetermined distance of a geographic location of the present transaction.

In step 408, the processing unit 204 may determine if any eligible prior transactions were identified in the previous step. If no prior transactions were identified (e.g., the present transaction is the first eligible transaction), then, in step 410, the processing unit 204 may identify the base amount included in the reward rule 210 as the reward to be awarded to the consumer 102. If prior transactions were identified, then, in step 412, the reward amount may be based on at least the base amount and an increase amount included in the reward rule 210. In some embodiments, the reward amount may be based on a reward amount awarded for the identified prior transaction and the increase amount included in the reward rule 210.

In step 414, the transmitting unit 206 of the reward processor 112 may transmit the identified reward amount (e.g., the base amount or an identified increased amount) to the issuer 110 for use in updating a reward profile of the consumer 102. In step 416, the transmitting unit 206 may also transmit a notification to the consumer 102 (e.g., via the computing device 114), notifying the consumer 102 of the awarded reward amount. It will be apparent to persons having skill in the relevant art that step 416 may be an optional step.

### Exemplary Method for Awarding Time-Based Incremental Rewards

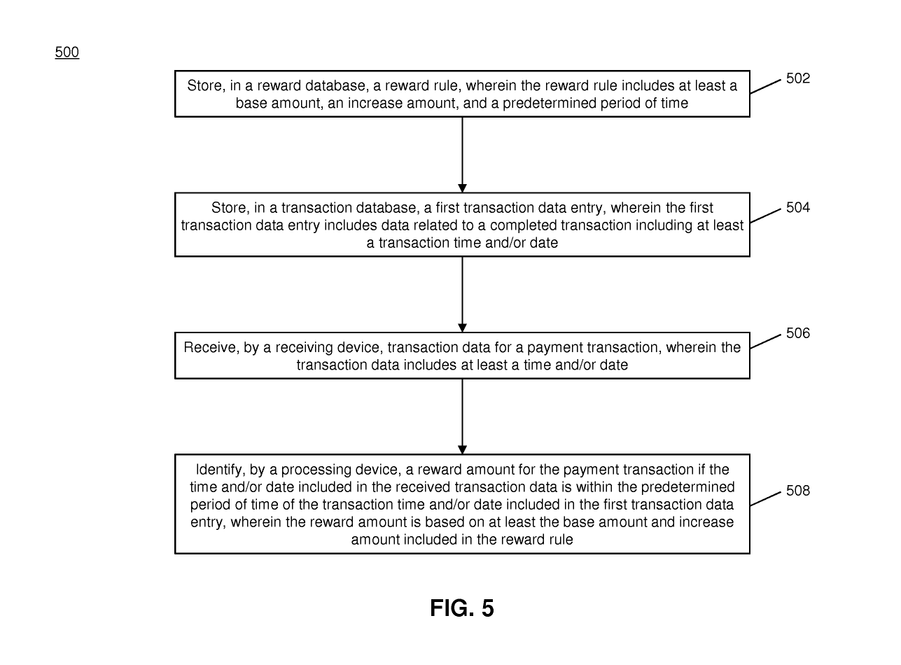

FIG. 5 illustrates a method 500 for awarding time-based, incremental rewards for a payment transaction.

In step 502, a reward rule (e.g., the reward rule 210) may be stored in a reward database (e.g., the reward database 208), wherein the reward rule 210 includes at least a base amount, an increase amount, and a predetermined period of time. In step 504, a first transaction data entry (e.g., transaction data entry 214) may be stored in a transaction database (e.g., the transaction database 212), wherein the first transaction data entry 214 includes data related to a completed transaction including at least a transaction time and/or date. In step 506, transaction data for a payment transaction may be received by a receiving device (e.g., the receiving unit 202), wherein the transaction data includes at least a time and/or date.

In step 508, a reward amount for the payment transaction may be identified, by a processing device (e.g., the processing unit 204), if the time and/or date included in the received transaction data is within the predetermined period of time of the transaction time and/or date included in the first transaction data entry 214, wherein the reward amount is based on at least the base amount and the increase amount included in the reward rule 210. In some embodiments, the method 500 may further include transmitting, by a transmitting device (e.g., the transmitting unit 206), the identified reward amount. In one embodiment, the received transaction data may further include a reward amount, and the reward amount may be further based on the transaction amount included in the received transaction data. In some embodiments, the reward rule 210 may further include a minimum transaction amount, the received transaction data may further include a transaction amount, and the reward amount may not be identified if the transaction amount included in the received transaction data does not exceed the minimum transaction amount included in the reward rule 210.

In one embodiment, the method 500 may further include storing, in the transaction database 212, a second transaction data entry 214, wherein the second transaction data entry 214 includes data related to the payment transaction including the time and/or date included in the received transaction data and the identified reward amount. In an even further embodiment, the method 500 may also include: receiving, by the receiving device 202, new transaction data for a new payment transaction, wherein the new transaction data includes a new time and/or date; and identifying, by the processing device 204, a new reward amount for the new payment transaction if the new time and/or date included in the received new transaction data is within the predetermined period of time of the time and/or date included in the second transaction data entry 214, wherein the new reward amount is based on at least the reward amount included in the second transaction data entry 214 and the increase amount included in the reward rule 210.

In some embodiments, the method 500 may further include: storing, in a consumer database (e.g., the consumer database 216), a consumer profile (e.g., the consumer profile 218), wherein the consumer profile 218 includes data related to a consumer (e.g., the consumer 102) involved in the payment transaction and includes at least a reward total; and updating, in the consumer profile 218, the reward total based on the identified reward amount. In a further embodiment, the consumer profile 218 may further include contact information, and the method 500 may even further include transmitting, by the transmitting device 206, a notification to the consumer 102 involved in the payment transaction, wherein the notification includes at least the identified reward amount.

### Computer System Architecture

FIG. 6 illustrates a computer system 600 in which embodiments of the present disclosure, or portions thereof, may be implemented as computer-readable code. For example, the reward processor 112 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for awarding time-based incremental rewards for a payment transaction. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for awarding time-based incremental rewards for a payment transaction, comprising:
storing, in a reward database, a reward rule, wherein the reward rule includes at least a base amount, an increase amount, and a predetermined period of time;
storing, in a transaction database, a first transaction data entry, wherein the first transaction data entry includes data related to a completed transaction including at least a transaction time and/or date;
receiving, by a receiving device, transaction data for a payment transaction, wherein the transaction data includes at least a time and/or date; and
identifying, by a processing device, a reward amount for the payment transaction if the time and/or date included in the received transaction data is within the predetermined period of time of the transaction time and/or date included in the first transaction data entry, wherein
the reward amount is based on at least the base amount and increase amount included in the reward rule.

2. The method of claim 1, further comprising:
storing, in the transaction database, a second transaction data entry, wherein the second transaction data entry includes data related to the payment transaction including the time and/or date included in the received transaction data and the identified reward amount.

3. The method of claim 2, further comprising:
receiving, by the receiving device, new transaction data for a new payment transaction, wherein the new transaction data includes a new time and/or date; and
identifying, by the processing device, a new reward amount for the new payment transaction if the new time and/or date included in the received new transaction data is within the predetermined period of time of the time and/or date included in the second transaction data entry, wherein
the new reward amount is based on at least the reward amount included in the second transaction data entry and the increase amount included in the reward rule.

4. The method of claim 1, wherein
the received transaction data further includes a transaction amount, and
the reward amount is further based on the transaction amount included in the received transaction data.

5. The method of claim 1, wherein
the reward rule further includes a minimum transaction amount,
the received transaction data further includes a transaction amount, and
the reward amount is not identified if the transaction amount included in the received transaction data does not exceed the minimum transaction amount included in the reward rule.

6. The method of claim 1, further comprising:
storing, in a consumer database, a consumer profile, wherein the consumer profile includes data related to a consumer involved in the payment transaction and includes at least a reward total; and
updating, in the consumer profile, the reward total based on the identified reward amount.

7. The method of claim 6, wherein the consumer profile further includes contact information, and the method further comprises:
transmitting, by a transmitting device, a notification to the consumer involved in the payment transaction, wherein the notification includes at least the identified reward amount.

8. The method of claim 1, further comprising:
transmitting, by a transmitting device, the identified reward amount.

9. A system for awarding time-based incremental rewards for a payment transaction, comprising:
a reward database configured to store a reward rule, wherein the reward rule includes at least a base amount, an increase amount, and a predetermined period of time;
a transaction database configured to store a first transaction data entry, wherein the first transaction data entry includes data related to a completed transaction including at least a transaction time and/or date;
a receiving device configured to receive transaction data for a payment transaction, wherein the transaction data includes at least a time and/or date; and
a processing device configured to identify a reward amount for the payment transaction if the time and/or date included in the received transaction data is within the predetermined period of time of the transaction time and/or date included in the first transaction data entry, wherein
the reward amount is based on at least the base amount and increase amount included in the reward rule.

10. The system of claim 9, wherein the processing device is further configured to store, in the transaction database, a second transaction data entry, wherein the second transaction data entry includes data related to the payment transaction including the time and/or date included in the received transaction data and the identified reward amount.

11. The system of claim 10, wherein
the receiving device is further configured to receive new transaction data for a new payment transaction, wherein the new transaction data includes a new time and/or date,
the processing device is further configured to identify a new reward amount for the new payment transaction if the new time and/or date included in the received new transaction data is within the predetermined period of time of the time and/or date included in the second transaction data entry, and
the new reward amount is based on at least the reward amount included in the second transaction data entry and the increase amount included in the reward rule.

12. The system of claim 9, wherein
the received transaction data further includes a transaction amount, and
the reward amount is further based on the transaction amount included in the received transaction data.

13. The system of claim 9, wherein
the reward rule further includes a minimum transaction amount,
the received transaction data further includes a transaction amount, and
the reward amount is not identified if the transaction amount included in the received transaction data does not exceed the minimum transaction amount included in the reward rule.

14. The system of claim 9, further comprising:
a consumer database configured to store a consumer profile, wherein
the consumer profile includes data related to a consumer involved in the payment transaction and includes at least a reward total, and
the processing device is further configured to update, in the consumer profile, the reward total based on the identified reward amount.

15. The system of claim 14, wherein the consumer profile further includes contact information, and the system further comprises:
a transmitting device configured to transmit a notification to the consumer involved in the payment transaction, wherein the notification includes at least the identified reward amount.

16. The system of claim 9, further comprising:
a transmitting device configured to transmit the identified reward amount.
